(19) United States
(12) Patent Application Publication
(10) Pub. No.: US 2006/0017699 A1
(43) Pub. Date: Jan. 26, 2006

(54) Electronic information display apparatus

(76) Inventor: Michael Wood Brown, Murrieta, CA (US)

Correspondence Address: David O. Simmons;Galasso & Associates LP, P.O. Box 26503, Austin, TX, 78755-0503, US

(21) Appl. No.: 11/187,353

(22) Filed: Jul. 20, 2005

Related U.S. Application Data
(60) Provisional application No. 60/590,831, filed on Jul. 22, 2004.

(51) Int. Cl. G09G 5/00

(52) U.S. Cl. 345/168

(57) ABSTRACT

An electronic information display apparatus specifically configured for use in a motor vehicle comprises a self-contained visual display unit and a self-contained information processing unit. The self-contained visual display unit includes a wireless receiver device configured for receiving display information data signals and at least one suction device enabling the visual display unit to be attached to a support surface. The self-contained information processing unit includes spell checking instructions accessible from a memory device of the self-contained information processing unit and a plurality of motor vehicle specific information display data selections accessible from the memory device of the self-contained information processing unit. The spell checking instructions are configured for checking spelling of display information inputted into the self-contained information processing unit. The wireless transmitter device is configured for transmitting display information data signals for reception by the wireless receiver device.

### CROSS REFERENCE TO RELATED APPLICATIONS

This patent application claims priority to co-pending U.S. Provisional Patent Application having Ser. No. 60/590,831 filed on Jul. 22, 2004 entitled “Car-Board”, having a common applicant herewith and being incorporated herein in its entirety by reference.

### FIELD OF THE DISCLOSURE

The disclosures made herein relate generally to electronic information display apparatuses and, more particularly, to electronic information display apparatuses in combination with or connected to a data input device such as a keyboard.

### BACKGROUND

Various types of electronic information display apparatuses configured specifically for presenting signage information and/or for communicating messages are known (i.e., conventional electronic information display apparatuses). One example of the usefulness and application for such conventional electronic information display apparatuses is general signage and/or message communication in a business establishment. Another example of the usefulness and application for such conventional electronic information display apparatuses is general signage and/or message communication in motor vehicle such as a car, van or bus. Furthermore, conventional electronic information display apparatuses may be configured for and/or used in a manner where a primary viewer of the signage information and/or communication messages views such signage information and/or communication messages through a window (e.g., a car window, a window of building, etc).

Conventional electronic information display apparatuses include a visual display unit on which visual information is displayed. The visual display unit includes a visual display device (e.g., a LCD screen), memory in which display information data is stored and a data processor device (e.g., a microprocessor). The data processor retrieves the display information data from the memory, interprets the display information and outputs a signal that controls the display of information on the visual display device.

A number of different approaches are used for providing display information data to conventional electronic information display apparatuses. One such approach is to create the display information data on a personal computing apparatus (e.g., a desktop computer or laptop computer) or application specific apparatus (e.g., available from a supplier of conventional electronic information display apparatuses) and download the display information data to memory of the electronic information display apparatus from the personal computing apparatus or application specific apparatus via an interface cable. Another such approach is for a data input module (e.g., including a keyboard and screen) that is integral with the electronic information display apparatus (e.g., housed within a common enclosure) to be used for creating the display information data and providing the display information data to memory of the electronic information display apparatus.

Clearly, the underlying information display functionality of conventional electronic information display apparatuses is useful. However, an electronic information display apparatus that is specifically configured for enabling grammatical accuracy in textual portions of display information, that simplifies the means by which display information data is created, that is readily portable and that provides for a convenient means of downloading display information data to memory of a visual display unit of the electronic information display apparatus will overcome one or more shortcomings associated with conventional electronic information display apparatuses.

### SUMMARY OF THE DISCLOSURE

Embodiments of the present invention enable signage information and/or messages to be conveniently conveyed. More specifically, embodiments of the present invention comprise an electronic information display apparatus configured for allowing signage information and/or messages to be generated, spell-checked and electronically displayed. Additionally, electronic information display apparatuses in accordance with the present invention are specifically configured in a manner enabling such signage information and/or messages to be conveniently generated and displayed in abroad range of applications and environments (e.g., businesses, motor vehicles, homes and the like).

In one embodiment of the present invention, an electronic information display apparatus comprises a visual display unit and an information processing unit. The visual display unit includes a wireless receiver device configured for receiving display information data signals. The information processing unit includes a wireless transmitter device configured for transmitting display information data signals for reception by the wireless receiver device and spell checking instructions accessible from a memory device of the information processing unit. The spell checking instructions are configured for checking spelling of display information data inputted into the information processing unit.

In another embodiment of the present invention, an electronic information display apparatus comprises a visual display unit and an information processing unit. The visual display unit includes a wireless receiver device, a visual display device, a data processing device, a memory device and a visual display unit housing. The wireless receiver device, the visual display device, the memory device and the data processing device are interconnected for enabling interaction therebetween and are mounted within the visual display unit housing. The wireless receiver device is configured for receiving display information data signals. The information processing unit includes a wireless transmitter device, a visual display device, a data processing device, a memory device and an information processing unit housing. The wireless transmitter device, the visual display device, the memory device and the data processing device are interconnected for enabling interaction therebetween and are mounted within the information processing unit housing. The wireless transmitter device is configured for transmitting display information data signals for reception by the wireless receiver device.

In another embodiment of the present invention, an electronic information display apparatus specifically configured for use in a motor vehicle comprises a self-contained visual display unit and a self-contained information processing unit. The self-contained visual display unit includes a wireless receiver device configured for receiving display information data signals and at least one suction device enabling the visual display unit to be attached to a support surface. The self-contained information processing unit includes spell checking instructions accessible from a memory device of the self-contained information processing unit and a plurality of motor vehicle specific information display data selections accessible from the memory device of the self-contained information processing unit. The spell checking instructions are configured for checking spelling of display information inputted into the self-contained information processing unit. The wireless transmitter device is configured for transmitting display information data signals for reception by the wireless receiver device.

Turning now to specific aspects of the present invention, in at least one embodiment, the information processing unit further comprises a plurality of pre-defined information display data selections accessible from the memory device of the information processing unit.

In at least one embodiment of the present invention, the information processing unit further comprises instructions configured for precluding the display information data signals from being transmitted for reception by the wireless receiver device until error in display information data has been at least one of corrected and overridden.

In at least one embodiment of the present invention, the information processing unit further comprises a visual display and a keyboard, the visual display and a keyboard are interconnected with the wireless transmitter device and the memory device of the information processing unit for enabling interaction therebetween, the keyboard is interconnected in a manner enabling display information data to be manually entered therethrough and the visual display is interconnected in a manner enabling the display information data to be displayed thereon.

In at least one embodiment of the present invention, the information processing unit further comprises a visual display unit housing having the wireless receiver device, the visual display device, the memory device and the data processing device mounted therein.

In at least one embodiment of the present invention, the visual display unit further comprises at least one suction device attached to the visual display unit housing and configured for enabling the visual display unit to be attached to a support surface.

In at least one embodiment of the present invention, the visual display device of the visual display unit is viewable through a front face of the visual display unit housing and the at least one suction device is attached to the visual display unit housing in a manner enabling the visual display unit to be attached to the support surface with the front face of the visual display unit housing substantially facing the support surface.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is an illustrative view of an electronic display apparatus in accordance with the present invention.

FIG. 2 is a block diagram view of the electronic display apparatus depicted in FIG. 1

FIG. 3 is a plan view of an information processing unit of the electronic display apparatus depicted in FIG. 1.

### DETAILED DESCRIPTION OF THE DRAWING FIGURES

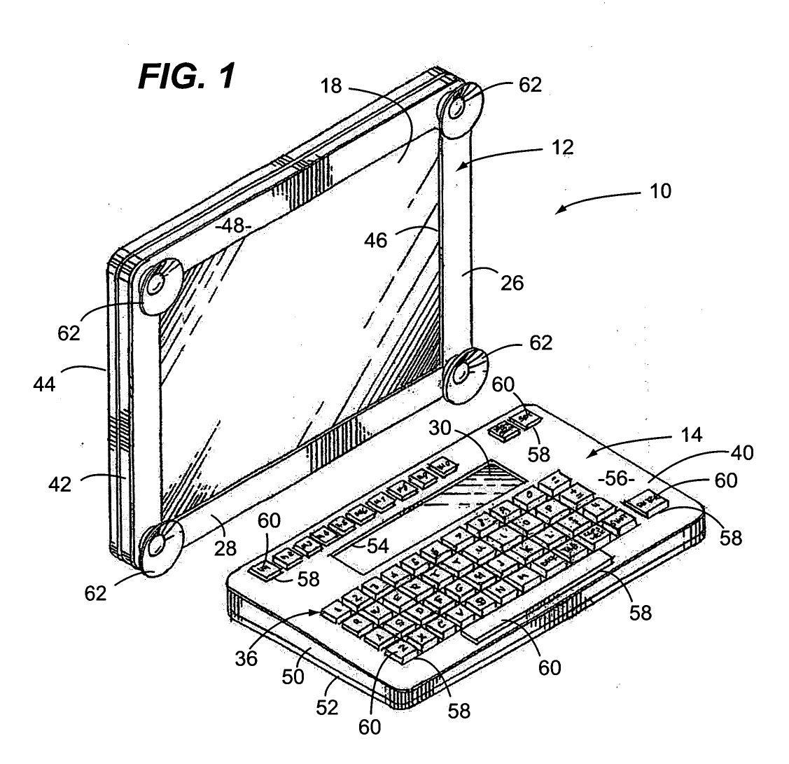

FIG. 1 depicts an embodiment of an electronic information display apparatus in accordance with the present invention, which is referred to herein as the electronic information display apparatus 10. The electronic information display apparatus 10 comprises a visual display unit 12 and an information processing unit 14. Jointly, as will be described herein in greater detail, the visual display unit 12 and the information processing unit 14 are configured for generating and displaying display information for being viewed by a general or specific audience.

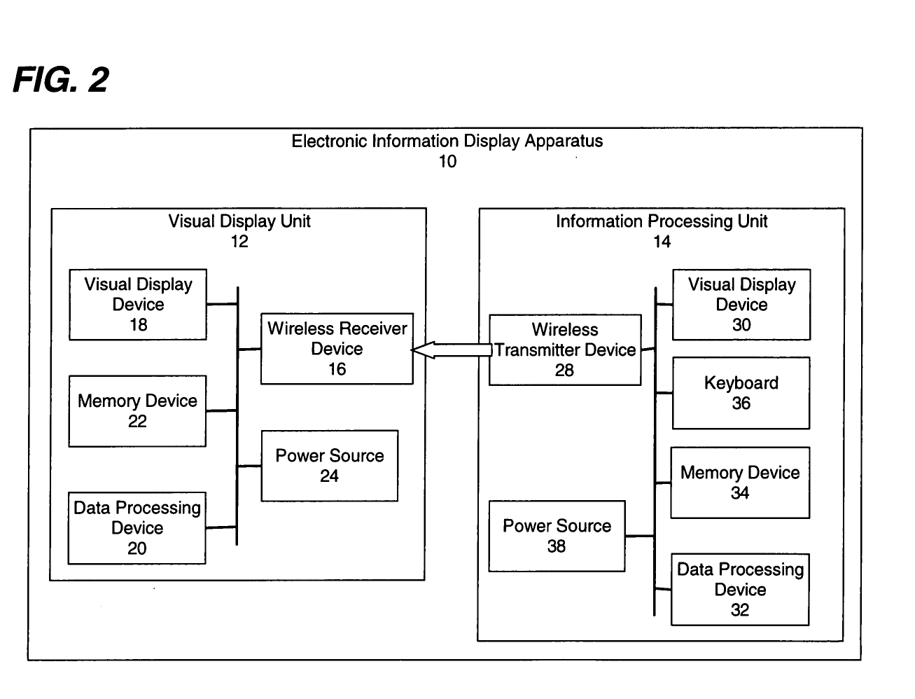

Referring now to FIGS. 1 and 2, the visual display unit 12 includes a wireless receiver device 16, a visual display device 18, a data processing device 20, a memory device 22, a power supply 24 and a visual display unit housing 26. The wireless receiver device 16, the visual display device 18, the data processing device 20, the memory device 22 and the power supply 24 are interconnected for enabling interaction therebetween and are contained within (e.g., are mounted within, attached to, etc) the visual display unit housing 26.

The information processing unit 14 includes a wireless transmitter device 28, a visual display device 30, a data processing device 32, a memory device 34, a keyboard 36, a power source 38 and an information processing unit housing 40. The wireless transmitter device 28, the visual display device 30, the data processing device 32, the memory device 34, the keyboard 36, and the power source 38 are interconnected for enabling interaction therebetween and are contained within (e.g., are mounted within, attached to, etc) the information processing unit housing 40.

Although not specifically depicted, it is disclosed herein that the visual display unit 12 and/or the information processing unit 14 may include other input and/or output devices. In one alternate embodiment, the visual display unit 12 and/or the information processing unit 14 include one or more audio input and/or output devices (e.g., a speakers, a microphone, etc.). In another alternate embodiment, the visual display unit 12 and/or the information processing unit 14 include an interface (e.g., a USB interface) configured for enabling external files (e.g., image files, text files or the like) to be uploaded.

As depicted in FIG. 1, the visual display unit housing 26 includes a front housing panel 42 and a rear housing panel 44 that jointly define an interior cavity in which the various components of the visual display unit 12 are contained. In this manner, the visual display unit 12 is self-contained. The front housing panel 42 of the visual display unit housing 26 has a visual display device opening 46 in a front face 48 thereof through which display information displayed on the visual display device 18 is viewable. The information processing unit housing 40 includes a front housing panel 50 and a rear housing panel 52 that jointly define an interior cavity in which the various components of the information processing unit 14 are contained. In this manner, the information processing unit 14 is self-contained. The front housing panel 28 of the visual display unit housing 26 has a visual display device opening 54 in a front face 56 thereof through which display information data displayed on the visual display device 30 is viewable. Additionally, the front housing panel 28 of the visual display unit housing 26 has a plurality of key openings 58 through which keys 60 of the keyboard 36 are accessible (e.g., extending through such openings).

The visual display unit 12 further comprises a plurality of suction devices 62 attached to the visual display unit housing 26, which enable the visual display unit 12 to be attached to a support surface. As depicted, the suction devices 62 are preferably, but not necessarily, attached to the visual display unit housing 26 in a manner enabling the visual display unit 12 to be attached to the support surface with the front face 48 of the visual display unit housing 26 substantially facing the support surface. Examples of such support surface include, but are not limited to, a window of a motor vehicle, a window of a business establishment, a window of a home, and the like.

It is disclosed herein that the suction devices 62 may be omitted from the visual display unit 12. In embodiment of the visual display unit 12 where the suction devices are omitted, the visual display unit 12 may be specifically configured for resting on a support surface (e.g., includes an integral stand, feet or the like) or for being hung on a support surface (e.g., includes means engagable with a picture hook or the like). The present invention is not unnecessarily limited by the various configurations by which the limited by the visual display unit 12 may be supported or attached to a support surface.

Referring to FIG. 2, the wireless receiver device 16 is configured for receiving display information data signals and the wireless transmitter device 28 is configured for transmitting display information data signals for reception by the wireless receiver device. A skilled person will appreciate that any number of specific transmitter-receiver circuities may be implemented. A chosen transmitter-receiver circuity will be selected based on factors such as cost, maximum desired transmit distance, frequency limit and frequency compatibility. One specific example of a suitable chosen transmitter-receiver circuity is transmitter-receiver circuitry configured in accordance with Bluetooth brand wireless technology.

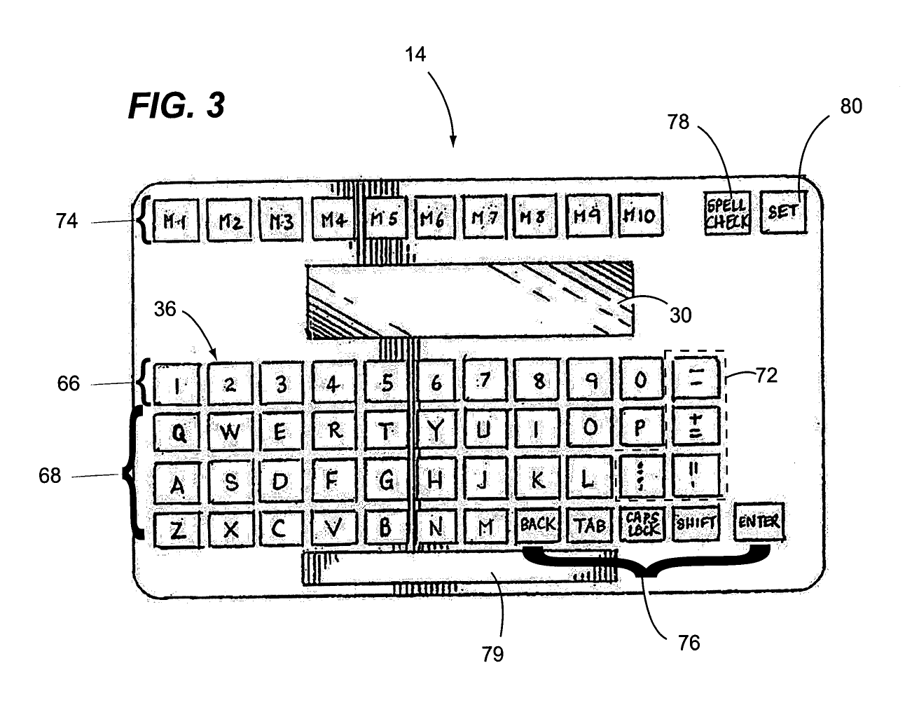

Referring now to FIGS. 1-3, the keyboard 36 of information processing unit 14 includes a plurality of keys. Examples of such keys include a plurality of numeric keys 66 (e.g., 0-9), a plurality of alpha keys 68 (e.g., A-Z), a space key 70, a plurality of special character keys 72, a plurality of special function keys 74, a plurality of control keys 76, a spell check key 78 and a set key 80. The plurality of numeric keys 66, the plurality of alpha keys 68 (e.g., A-Z) and the plurality of special character keys 72 are used for compiling display information data (i.e., signage information and messages) that a user desires to display on the visual display device 18 of the visual display unit 12. The plurality of control keys 76 provide functionality such as, for example, cursor movement, capital lock, key shift selection, line enter and the like. The plurality of special function keys 74 provide for pre-defined and/or user prescribed special functionality such as, for example, display of special menus and/or lists, prescribed keystroke functionality, help menu display, and the like. In general, the numeric keys 66, the alpha keys 68, the space key 70, the special character keys 72, the special function keys 74 and the control keys 76 provide conventional utility.

In one specific embodiment of the present invention, a plurality of pre-defined information display data selections, which are accessible from the memory device 34 of the information processing unit, are displayable on the visual display device 30 by selection of a prescribed one of the special function keys 74. One or more of the pre-defined information display data selections may be selected (e.g., by tabbing to a desired selection) and displayed on the visual display device. Through such function, a pre-defined information display data selection may be retrieved and used as information display data, which may be displayed as-is or modified to suit a specific need/desire. Examples of such pre-defined information display data selections include, but are not limited to, selections related to disabled motor vehicle situations (e.g., “flat tire”, “need jumper cables”, “need a gas can”, and the like), selections related to business related situations (e.g., “sale today”, “open late”, “last day of sale”, and the like). A skilled person will appreciate that the present invention is not limited by particular display information that may or may not be displayable on particular embodiments of an electronic information display apparatus in accordance with the present invention.

The spell check key 78 and the set key 80 provide for distinguishing functionality in accordance with the present invention. Selection of the spell check key 78 activates spell check functionality in accordance with the present invention. In one embodiment of such spell check functionality, the information processing unit 14 includes spell checking instructions accessible from the memory device 34 of the information processing unit 14 and/or the device 22 of the visual display unit 12. The spell checking instructions are configured for carrying out spell checking (e.g., including grammar checking) of display information (e.g., signage information and/or messages) inputted into the information processing unit 14. The set key 80 is selected for initiating transmission of a display information data signal corresponding to display information displayed on the visual display device 30 of the information processing unit 14 for reception by the visual display unit 12 and display on the visual display device 18 of the visual display unit 12.

Preferably, but not necessarily, the ability to transmission of display information data for reception and display by the visual display unit 12 is dependent upon the spell check functionality in accordance with the present invention. In such an embodiment, instructions are provided for precluding the display information data signals from being transmitted from the wireless transmitter device 28 for reception by the wireless receiver device 16 until error (i.e. one or more errors) in display information data has been corrected or overridden. In this manner, a safeguard is provided for enhancing proper grammar and spelling of displayed information.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claim is:

1. An electronic information display apparatus, comprising:
a visual display unit including a wireless receiver device configured for receiving display information data signals; and
an information processing unit including a wireless transmitter device configured for transmitting display information data signals for reception by the wireless receiver device; and
spell checking instructions configured for checking spelling of display information data inputted into the information processing unit.

2. The electronic information display apparatus of claim 1 wherein the spell checking instructions are accessible from a memory device of at least one of the information processing unit and the visual display unit.

3. The electronic information display apparatus of claim 1, further comprising:
instructions configured for precluding said display information data signals from being transmitted for reception by the wireless receiver device until error in display information data has been at least one of corrected and overridden, wherein said instructions are accessible from memory of at least one the information processing unit and the visual display unit.

4. The electronic information display apparatus of claim 1, further comprising:
instructions for displaying a plurality of pre-defined information display data selections, wherein said instructions are accessible from memory of at least one the information processing unit and the visual display unit.

5. The electronic information display apparatus of claim 1 wherein:
the information processing unit further comprises a visual display and a keyboard;
the visual display and a keyboard are interconnected with the wireless transmitter device and the memory device of the information processing unit for enabling interaction therebetween;
the keyboard is interconnected in a manner enabling display information data to be manually entered therethrough; and
the visual display is interconnected in a manner enabling said display information data to be displayed thereon.

6. The electronic information display apparatus of claim 5, further comprising:
instructions configured for precluding said display information data signals from being transmitted for reception by the wireless receiver device until error in display information data has been at least one of corrected and overridden; and
instructions for displaying a plurality of pre-defined information display data selections.

7. The electronic information display apparatus of claim 6 wherein:
the information processing unit further comprises a visual display unit housing, wherein the wireless receiver device, the visual display device, the memory device and the data processing device are mounted within the visual display unit housing; and
the visual display unit further comprises at least one suction device attached to the visual display unit housing and configured for enabling the visual display unit to be attached to a support surface.

8. The electronic information display apparatus of claim 7 wherein:
the visual display device of the visual display unit is viewable through a front face of the visual display unit housing; and
said at least one suction device is attached to the visual display unit housing in a manner enabling the visual display unit to be attached to the support surface with the front face of the visual display unit housing substantially facing the support surface.

9. An electronic information display apparatus, comprising:
a visual display unit including a wireless receiver device, a visual display device, a data processing device, a memory device and a visual display unit housing, wherein the wireless receiver device, the visual display device, the memory device and the data processing device are interconnected for enabling interaction therebetween and are mounted within the visual display unit housing and wherein the wireless receiver device is configured for receiving display information data signals; and
an information processing unit including a wireless transmitter device, a visual display device, a data processing device, a memory device and an information processing unit housing, wherein the wireless transmitter device, the visual display device, the memory device and the data processing device are interconnected for enabling interaction therebetween and are mounted within the information processing unit housing, wherein the wireless transmitter device is configured for transmitting display information data signals for reception by the wireless receiver device.

10. The electronic information display apparatus of claim 9 wherein the information processing unit further comprises:
instructions configured for precluding said display information data signals from being transmitted for reception by the wireless receiver device until error in display information data has been at least one of corrected and overridden.

11. The electronic information display apparatus of claim 9 wherein the information processing unit further comprises:
a plurality of pre-defined information display data selections accessible from the memory device of the information processing unit.

12. The electronic information display apparatus of claim 9 wherein the information processing unit further comprises:
instructions configured for precluding said display information data signals from being transmitted for reception by the wireless receiver device until error in display information data has been at least one of corrected and overridden; and
a plurality of pre-defined information display data selections accessible from the memory device of the information processing unit.

13. The electronic information display apparatus of claim 12 wherein the visual display unit further comprises:
at least one suction device attached to the visual display unit housing and configured for enabling the visual display unit to be attached to a support surface.

14. The electronic information display apparatus of claim 13 wherein:
the visual display device of the visual display unit is viewable through a front face of the visual display unit housing; and
said at least one suction device is attached to the visual display unit housing in a manner enabling the visual display unit to be attached to the support surface with the front face of the visual display unit housing substantially facing the support surface.

15. An electronic information display apparatus specifically configured for use in a motor vehicle, comprising:
a self-contained visual display unit including a wireless receiver device configured for receiving display information data signals and at least one suction device enabling the visual display unit to be attached to a support surface; and
a self-contained information processing unit including spell checking instructions accessible from a memory device of the self-contained information processing unit and a plurality of motor vehicle specific information display data selections accessible from the memory device of the self-contained information processing unit, wherein said spell checking instructions are configured for checking spelling of display information data inputted into the self-contained information processing unit and wherein the wireless transmitter device is configured for transmitting display information data signals for reception by the wireless receiver device.

16. The electronic information display apparatus of claim 15 wherein:
the self-contained information processing unit further comprises a visual display and a keyboard;
the visual display and a keyboard are interconnected with the wireless transmitter device and the memory device of the self-contained information processing unit for enabling interaction therebetween;
the keyboard is interconnected in a manner enabling display information data to be manually entered therethrough; and
the visual display is interconnected in a manner enabling said display information data to be displayed thereon.

17. The electronic information display apparatus of claim 16 wherein:
the self-contained information processing unit further comprises a visual display unit housing, wherein the wireless receiver device, the visual display device, the memory device and the data processing device are mounted within the visual display unit housing; and
the self-contained visual display unit further comprises at least one suction device attached to the visual display unit housing and configured for enabling the visual display unit to be attached to a support surface.

18. The electronic information display apparatus of claim 17 wherein:
the visual display device of the self-contained visual display unit is viewable through a front face of the visual display unit housing; and
said at least one suction device is attached to the visual display unit housing in a manner enabling the self-contained visual display unit to be attached to the support surface with the front face of the visual display unit housing substantially facing the support surface.
